(19) United States
(12) Patent Application Publication
(10) Pub. No.: US 2025/0247767 A1
(43) Pub. Date: Jul. 31, 2025

(54) SELECTIVE DEVICE TUNNELING AND LOCAL NETWORK CONNECTIVITY

(71) Applicant: Charter Communications Operating, LLC, St. Louis, MO (US)

(72) Inventors: Shane B. Newberg, Aurora, CO (US); Ahmed Bencheikh, Lorton, VA (US)

(21) Appl. No.: 18/426,893

(22) Filed: Jan. 30, 2024

(51) Int. Cl. H04W 40/22; H04W 8/26; H04W 40/24

(52) U.S. Cl. CPC H04W 40/22; H04W 8/26; H04W 40/248

(57) ABSTRACT

A communication management system receives a first communication from a first communication device. Based on an identity of the first communication device, the communication management system selects a first gateway network address amongst multiple gateway network addresses in which to forward the first communication from the router. Via the first gateway network address, the communication management system transmits the first communication from the router for delivery of the first communication to a destination as specified by the first communication. Implementation of the multiple gateway network addresses is useful because it provides different options for communicating data outbound from the router. For example, the communication device connected to a respective local area network (via layer 2 communications) is able to communicate with other devices in the respective local area network while a specific gateway network address supports (via layer 3 coordination) communications over a respective tunnel outbound from the router.

### BACKGROUND

Conventional wireless networks typically include one or more wireless base stations or wireless access points to provide mobile communication devices (a.k.a., user equipment) access to a remote network such as the Internet or other remote networks.

A wireless access point such as a router can be configured with multiple SSIDs to support different wireless networks connecting different groups of wireless communication devices to each other and one or more remote networks. In certain instances, the wireless access point may receive communications from a mobile communication device for delivery to a remote network. In such an instance, a so-called default gateway associated with the router may be used as a basis in which to forward such communications from the conventional router to the remote network.

### BRIEF DESCRIPTION OF EMBODIMENTS

This disclosure includes the observation that implementation of many different wireless networks from a single router may be inefficient because of the overhead associated with supporting each of the different wireless networks. For example, supporting outbound communications from a wireless access point may result in the need for the wireless access point to support additional wireless networks. More specifically, a first wireless network provided by the wireless access point may support local communications between a first mobile communication device and other communication devices in the local area network supported by the router. A second wireless network may be needed to support communications from the first mobile communication device outbound to a second network outside of the local area network. The second wireless network cannot be used to communicate with the communication devices in the first wireless network

To address the deficiency associated with conventional techniques, examples herein include a router providing selective tunneling to one or more communication devices. Assume that communication devices in a local network are able to communicate with each other via communications through the router. As discussed herein, certain communication devices in the local network are providing communication tunneling outbound from the router to the Internet or other remote network using an assigned gateway address selected amongst multiple gateway network addresses. Each of the different gateway network addresses as discussed herein can be configured to provide different levels of service to the communication devices that are connected to a particular local area network.

More specifically, in one implementation, assume that a router receives a message from a first communication device that is connected to a first local area network supported by the router. Based on an identity of the first communication device, a communication management resource associated with the router a first gateway network address assigned to the first communication device. The first gateway network address is selected amongst multiple gateway network addresses for use by the first communication device. The communication management resource provides notification of the assigned first gateway network address to the first communication device. As its name suggests, the first gateway network address specifies a first gateway of multiple gateways associated with the router. The first communication device then uses the assigned first gateway network address as a basis to communicate any data packets destined for delivery to one or more destinations outside of the first local area network. For example, use of the first gateway network address enables a communication management resource associated with the router to receive first communications from the first communication device using an SSID supporting the first local area network. The communication management resource and router forward those data packets (first communications) through a gateway specified by the first gateway network address to one or more destinations as specified by the first communication device.

In further examples, the first local area network supports conveyance of second communications amongst multiple communication devices connected to the first local area network. The multiple communication devices may include the first communication device and a second communication device as well as other communication devices.

In accordance with yet further examples as discussed herein, the first gateway network address is assigned to support conveyance of the first communications between the router and a remote termination node through a secure tunnel. The first gateway network address supports conveyance of the first communications over the secure tunnel between the router and the remote termination node.

Yet further, as discussed herein, note that the remote termination node may be a wireless access gateway. The communication management resource can be configured to transmit the first communications from the router via the selected first gateway network address through the secure tunnel to at least one destination.

Still further, the communication management resource as discussed herein can be configured to receive the first communications as encapsulated messages generated by the first communication device or other suitable entity. Additionally, the communication management resource can be configured to transmit the received first communications from the router through a secure tunnel associated with the first gateway network address for delivery to the at least one destination.

As further discussed herein, the first local area network may be a first wireless network as indicated by a respective network name. The router receives the message over the first local area network. As previously discussed, the first local area network can be configured to provide wireless connectivity of the first communication device to a second communication device in the wireless network through the router. The router further supports transmitting the first communications as encapsulated messages over and through a secure tunnel associated with the first gateway network address to the at least one destination.

Further, the router as discussed herein can be configured to receive a message inquiring about a default wireless gateway in a wireless signal transmitted from the first communication device to the router. As previously discussed, assignment of the first gateway network address to the communication device enables the first communication device to communicate with the remote network.

Note further that selection of the first gateway network address for use by the first communication device may include the router and/or communication management resource performing operations such as retrieving a unique identifier value from the message, the unique identifier value indicating the identity of the first communication device; and mapping the unique identifier value to the first gateway network address amongst the multiple gateway network addresses.

As another example of the router supporting connectivity to the remote network, the communication management resource associated with the router as discussed herein can be configured to receive a second message from a second communication device. The second communication device also may be connected or request to be connected to the first local area network supported by the router. Based on an identity of the second communication device, the communication management resource associated with the router can be configured to select a second gateway network address amongst the multiple gateway network addresses in which to forward second communications received from the second communication device from the router outside of the first local area network. Upon receiving the second communications from the second communication device, the communication management resource transmits the second communications from the router to the selected second gateway network address for delivery of the second communications to a second destination as specified by the second communications.

Note further that the selection of the second gateway network address for use by the second communication device may include the communication management resource: retrieving a unique identifier value from the second message received from the second communication device, the unique identifier value retrieved from the second message specifying an identity of the second communication device; and mapping the unique identifier value retrieved from the second message to the second gateway network address.

As previously discussed, in one example, the first communication device and the second communication device are in communication with each other over the first local area network. The first local area network may be one of multiple wireless networks (SSID1, SSID2, etc.) supported by the router. Implementation of the multiple gateway network addresses for the same SSID1 supporting the local area network prevents the first communication device from having to join two different networks such as a first network such as assigned SSID1 supporting wireless connectivity with other communication devices wirelessly connected to the router and a second network such as assigned SSID2 supporting wireless connectivity of the communication device through the router to a remote network outside of the first network. As previously discussed, and as further discussed herein, reducing the number of different wireless networks supported by a router provides more efficient use of respective wireless resources and allows different devices to communicate with each other when they are on the same local area network.

Note that any of the resources as discussed herein can include one or more computerized devices, mobile communication devices, servers, base stations, wireless communication equipment, communication management systems, controllers, workstations, user equipment, handheld or laptop computers, or the like to carry out and/or support any or all of the method operations disclosed herein. In other words, one or more computerized devices or processors can be programmed and/or configured to operate as explained herein to carry out the different embodiments as described herein.

Yet other embodiments herein include software programs to perform the steps and operations summarized above and disclosed in detail below. One such embodiment comprises a computer program product including a non-transitory computer-readable storage medium or any computer readable storage hardware on which software instructions are encoded for subsequent execution. The instructions, when executed in a computerized device (hardware) having a processor, program and/or cause the processor (hardware) to perform the operations disclosed herein. Such arrangements are typically provided as software, code, instructions, firmware, and/or other data (e.g., data structures) arranged or encoded on a non-transitory computer readable storage medium such as an optical medium (e.g., CD-ROM), floppy disk, hard disk, memory stick, memory device, etc., or other a medium such as one or more ROM, RAM, PROM, etc., or as an Application Specific Integrated Circuit (ASIC), etc. The software or firmware or other such configurations can be installed onto a computerized device to cause the computerized device to perform the techniques explained herein.

Accordingly, embodiments herein are directed to a method, system, computer program product, etc., that supports operations as discussed herein.

One embodiment includes a computer readable storage medium and/or system having instructions stored thereon. The instructions, when executed by computer processor hardware, cause the computer processor hardware (such as one or more co-located or disparately processor devices or hardware) to: receive a message from a first communication device connected to a first local area network supported by the router; based on an identity of the first communication device, select a first gateway network address amongst multiple gateway network addresses in which to forward first communications received from the first communication device from the router to one or more destinations outside of the first local area network; and assign the first gateway network address to the first communication device for delivery of the first communications from the first communication device to the one or more destinations.

The ordering of the steps above has been added for clarity sake. Note that any of the processing steps as discussed herein can be performed in any suitable order.

Other embodiments of the present disclosure include software programs and/or respective hardware to perform any of the method embodiment steps and operations summarized above and disclosed in detail below.

It is to be understood that the system, method, apparatus, instructions on computer readable storage media, etc., as discussed herein also can be embodied strictly as a software program, firmware, as a hybrid of software, hardware and/or firmware, or as hardware alone such as within a processor (hardware or software), or within an operating system or a within a software application.

As discussed herein, techniques herein are well suited for use in the field of providing network access and wireless services to communication devices. However, it should be noted that embodiments herein are not limited to use in such applications and that the techniques discussed herein are well suited for other applications as well.

Additionally, note that although each of the different features, techniques, configurations, etc., herein may be discussed in different places of this disclosure, it is intended, where suitable, that each of the concepts can optionally be executed independently of each other or in combination with each other. Accordingly, the one or more present inventions as described herein can be embodied and viewed in many different ways.

Also, note that this preliminary discussion of embodiments herein (BRIEF DESCRIPTION OF EMBODIMENTS) purposefully does not specify every embodiment and/or incrementally novel aspect of the present disclosure or claimed invention(s). Instead, this brief description only presents general embodiments and corresponding points of novelty over conventional techniques. For additional details and/or possible perspectives (permutations) of the invention(s), the reader is directed to the Detailed Description section (which is a summary of embodiments) and corresponding figures of the present disclosure as further discussed below.

### BRIEF DESCRIPTION OF THE DRAWINGS

FIG. 1 is an example diagram illustrating a wireless network environment and implementation of multiple gateway network addresses to provide multiple communication devices connectivity to a remote network as discussed herein.

FIG. 2 is an example diagram illustrating implementation of access control information to control conveyance of communications as discussed herein.

FIG. 3 is an example diagram illustrating assignment of a first gateway network address for use by a first communication device as discussed herein.

FIG. 4 is an example diagram illustrating forwarding of first communications from the first communication device using the first gateway network address assigned to the first communication device as discussed herein.

FIG. 5 is an example diagram illustrating an encapsulated data packet supporting outbound communications from the first communication device and the local area network to one or more communication devices in a remote network as discussed herein.

FIG. 6 is an example diagram illustrating assignment of a second gateway network address for use by a second communication device as discussed herein.

FIG. 7 is an example diagram illustrating forwarding of second communications from the second communication device using the second gateway network address as discussed herein.

FIG. 8 is an example diagram illustrating implementation of a cable modem communication system to support conveyance of communications as discussed herein.

FIG. 9 is an example diagram illustrating example computer architecture operable to execute one or more operations as discussed herein.

FIG. 10 is an example diagram illustrating a method as discussed herein.

The foregoing and other objects, features, and advantages of the invention will be apparent from the following more particular description of preferred embodiments herein, as illustrated in the accompanying drawings in which like reference characters refer to the same parts throughout the different views. The drawings are not necessarily to scale, with emphasis instead being placed upon illustrating the embodiments, principles, concepts, etc.

### DETAILED DESCRIPTION

This disclosure includes the observation that conventional systems assign a same default gateway to all devices on a LAN (Local Area Network). The same default gateway supports connectivity of those devices outside of the LAN to one or more remote networks. In a case of wanting some devices on the LAN to be tunneled across the WAN to join another network outside of the LAN, but other devices on the LAN to use the traditional gateway on the same LAN, there is potentially conflicting behavior between what a default gateway network address the (Dynamic Host Communication Protocol) server assigns to a communication device for use, and the need for a gateway that tunnels communications associated with a device on the LAN into another network.

So-called CPE (Customer Premises Equipment) Routers use their own IP address and LAN to apply a rule to determine if the desire is to forward packet to Internet, or encapsulate the packet into a tunnel. Current router implementations today do not consider utilizing more than one gateway on the same LAN to determine next hop policy and tunneling logic determination.

In contrast to conventional techniques, examples herein include implementation of a DHCP (Dynamic Host Communication Protocol) server supporting selective tunneling to different communication devices through a router, while still providing local network connectivity to those communication devices through the router.

Devices that do not need to be tunneled to another network are treated normally, with the DHCP server assigning the IP address, Subnet mask, DNS, and default gateway into their traditional CPE router for traffic from a respective communication device to be forwarded out of the local area network to the Internet.

For communication devices where it is desirable to support both connectivity to that local LAN, but their Internet Access is to be through another network, with different policies for that network, techniques herein include assignment of different DHCP values for that device in terms of default gateway, and possible DNS depending on network policy.

For example, as discussed herein, a mobile communication device on a respective first wireless local area network is able to communicate with other devices on the respective first wireless local area network, while the mobile communication device is provided outbound services from the first local area network through the router to another network via selective tunneling an assignment of a respective gateway address selected amongst multiple gateway addresses.

In certain instances, the outbound services of supporting connectivity of the mobile communication device in the local area network to another network can include implementing an Optional Speed Boost architecture that uses the GRE (Generic Routing Encapsulation) tunnel to implement a respective data flow speed policy, but still allow a mobile communication device to connect to the local area network.

As further discussed herein, the DHCP process of supporting wireless connectivity can be modified on the CPE local router to query a centralized database and determine if a respective MAC (Media Access Control) address or other device identification of the mobile communication device matches a device policy that would cause a VPN to be established between the CPE router and the remote network.

The DHCP process as discussed herein can be configured to assign a different default gateway on the local LAN for the different communication devices in the local area network such that the second gateway is used to establish the VN (Virtual Network) endpoint for devices proceeding into the VPN tunnel. The DHCP process as discussed herein may be interfaced with the DHCP process of the remote LAN such that IP assignment of the local LAN and remote network are synchronized to allow the remote network to utilize the IP assignment from the local LAN.

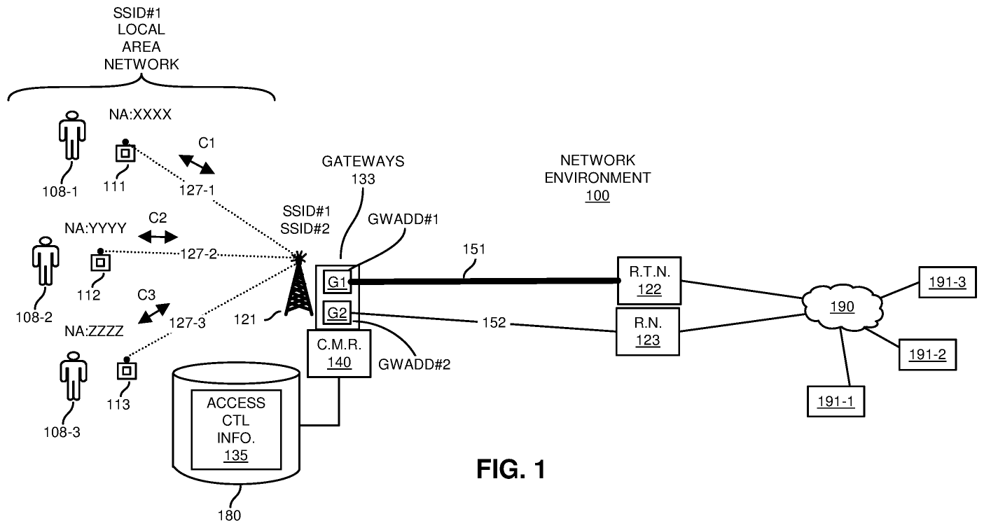

Now, more specifically, FIG. 1 is an example diagram illustrating a wireless network environment and implementation of multiple gateway network addresses to provide connectivity to a remote network as discussed herein.

As shown in FIG. 1, the network environment 100 includes multiple mobile communication devices such as mobile communication device 111, mobile communication device 112, mobile communication device 113, etc.

Further, the network environment 100 includes wireless access point 121 (such as a router), communication management resource 140, repository 180 (such as a database), and remote termination node 122 (such as wireless gateway or other suitable entity such as a virtual private network termination node).

Note that each of the resources as described herein can be configured as hardware, software, or combination of both hardware and software.

More specifically, the communication management resource 140 can be implemented as communication management hardware, communication management software, or combination of communication management hardware and communication management software; wireless access point 121 can be configured as wireless access point hardware, wireless access point software, or a combination of wireless access point hardware and wireless access point software; remote termination node 122 can be configured as remote termination node hardware, remote termination node software, or a combination of remote termination node hardware and remote termination node software; remote node 123 can be configured as remote node hardware remote node software, or a combination of remote node hardware and remote node software; and so on.

As further shown, the wireless access point 121 supports one or more wireless networks such as a first local area network identified by the network name SSID #1,second local area network identified by the network name SSID #2,etc.

Assume in this example that each of the mobile communication devices including mobile communication device 111, mobile communication device 112, mobile communication device 113 join the first local area network identified by the network name SSID #1.

The wireless access point 121 can be configured to wirelessly communicate its presence via transmission of a wireless signal or beacon indicating its availability to the communication devices in the network 100. For those devices that wish to join the local area network, joining the respective network as indicated by the SSID #1 can include each of the mobile communication devices providing credentials to establish a respective wireless communication link with the wireless access point 121.

For example, the mobile communication device 111 establishes the wireless communication link 127-1 with the wireless access point 121; the mobile communication device 112 establishes the wireless communication link 127-2 with the wireless access point 121; the mobile communication device 113 establishes the wireless communication link 127-3 with the wireless access point 121; and so on.

Assume that each of the wireless communication links 127-1, 127-2, and 127-3 are part of a local area network supported by the network identifier SSID #1.

Yet further, in one example, each of the mobile communication devices is assigned a respective unique network address from any suitable entity in the network environment 100. For example, the mobile communication device 111 can be assigned network address of XXXX; the mobile communication device 112 can be assigned network address of YYYY; the mobile communication device 130 can be assigned the network address ZZZZ.

Note further that each of the mobile communication devices can be assigned a respective unique MAC address in addition to IP (Internet Protocol) addresses such as the above-mentioned network addresses XXXX, YYYY, and ZZZZ.

Further in this example, the local area network assigned the network name SSID #1 and corresponding wireless access point 121 support local connectivity amongst the respective communication devices via layer 2 communications. For example, each of the mobile communication devices in the local area network can be configured to send out a respective request (ARP request) to learn of which MAC address is assigned to each of the other communication devices in the local network supported by the SSID #1.

The ARP (Address Resolution Protocol) request packet may include the source MAC address and the source IP address and the destination IP address of a requesting communication device. Each communication device (such as host) in the local network other than the sender communication device receives this packet. The communication device with the specified destination IP address in the request, sends an ARP reply packet to the originating host with its IP address. In such an instance, for each of the devices present in the network such as communication device 112, communication device 113, etc., the mobile communication device 111 is able to identify presence of and information associated with other communication devices in the local area network (which includes wireless communication link 127-1, wireless communication link 127-2, and wireless communication link 127-3).

Additionally, via the MAC addresses associated with the different mobile communication devices, the mobile communication device 111 is able to transmit communications through the wireless access point 121 to the mobile communication device 112; the mobile communication device 111 is able to transmit communications through the wireless access point 121 to the mobile communication device 113.

In a similar manner, the mobile communication device 112 is able to identify presence of other communication devices in the local area network (which includes wireless communication link 127-1, wireless communication link 127-2, and wireless communication link 127-3). Additionally, via the MAC addresses associated with the different mobile communication devices, the mobile communication device 112 is able to transmit communications through the wireless access point 121 to the mobile communication device 111; the mobile communication device 112 is able to transmit communications through the wireless access point 121 to the mobile communication device 113.

In addition to supporting the local communications with other communication devices in the local area network (a.k.a., VLAN or Virtual Local Area Network), the wireless access point 121 can be configured to support connectivity of the one or more communication devices with the remote network 190 such as the Internet. In such an instance, the communication devices in the local area network are able to communicate amongst themselves as well as communicate through the one or more gateways 133 with any of one or more remote communication devices 191-1, 191-2, 191-3, etc., in the network 190

Yet further, note that each of the mobile communication devices in the local area network may be assigned a different service level to access the communication devices 191 in the remote network 190.

For example, a first subscriber such as a user 108-1 operating the mobile communication device 111 can be assigned the highest level of service (such as high-speed data rate of 1 gigabyte per second data throughput) through the wireless access point 121 and gateways 133 to the remote network 190.

A second subscriber such as a user 108-2 operating the mobile communication device 112 can be assigned a lowest level of service (such as high-speed data rate of 200 megabytes per second data throughput) through the wireless access point 121 and gateways 133 to the remote network 190.

A third subscriber such as a user 108-3 operating the mobile communication device 113 can be assigned a lowest level of service (such as high-speed data rate of 200 megabytes per second data throughput) through the wireless access point 121 and gateways 133 to the remote network 190.

To support the different throughput capabilities, the network environment 100 includes access control information 135 stored in the respective repository 180.

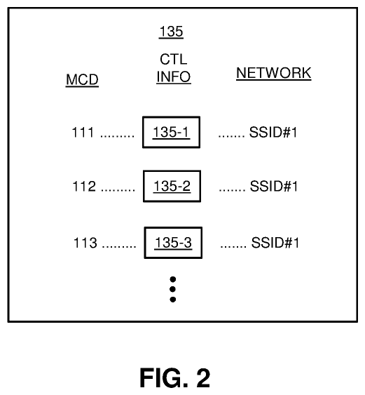

As shown in FIG. 2, the access control information 135 can be configured to indicate any suitable information supporting wireless communications associated with the different mobile communication devices.

FIG. 2 is an example diagram illustrating implementation of access control information to control forwarding of communications as discussed herein.

In this example, the access control information 135 includes access control information for each of the different mobile communication devices.

For example, the access control information 135 indicates that: i) the access control information 135-1 is assigned to the mobile communication device 111 for use of the wireless network as specified by SSID #1; ii) the access control information 135-2 is assigned to the mobile communication device 112 for use of the wireless network as specified by SSID #1; iii) the access control information 135-3 is assigned to the mobile communication device 113 for use of the wireless network as specified by SSID #1; and so on.

Note that the access control information associated with each of the mobile communication devices may be applicable to multiple SSIDs and not just a single as SSID.

Note further that the access control information associated with each of the different mobile communication devices can specify any suitable information.

In one example, the access control information 135-1 assigned to the mobile communication device 111 indicates that the mobile communication device 111 is assigned the gateway network address #1 (corresponding gateway G1 of the multiple gateways 133) to support outbound communications from the wireless access point 121 and corresponding communication management resource 140 to the remote network 190. Via the access control information 135-1, the mobile communication device 111 is assigned a higher than normal data flow rate such as one gigabytes per second or other suitable amount for uplink or downlink communications between the wireless access point 121 and the network 190.

Further in this example, the access control information 135-2 assigned to the mobile communication device 112 indicates that the mobile communication device 112 is assigned the gateway network address #2 (corresponding gateway G2 of the multiple gateways 133) to support outbound communications from the wireless access point 121 to the remote network 190. The mobile communication device 112 is assigned a normal data flow rate such as 200 megabytes per second or other suitable amount for uplink and/or downlink communications between the wireless access point 121 and the network 190.

Yet further in this example, the access control information 135-3 assigned to the mobile communication device 113 indicates that the mobile communication device 113 is assigned the gateway network address #2 (corresponding gateway G2) to support outbound communications from the wireless access point 121 to the remote network 190. The mobile communication device 113 is assigned a normal data flow rate such as 200 megabytes per second or other suitable amount for uplink and/or downlink communications between the wireless access point 121 and the network 190.

Note that any suitable one or more resources dispose between the wireless access point 121 and the network 190 can be configured to control the rate of data flow associated with each of the communication devices.

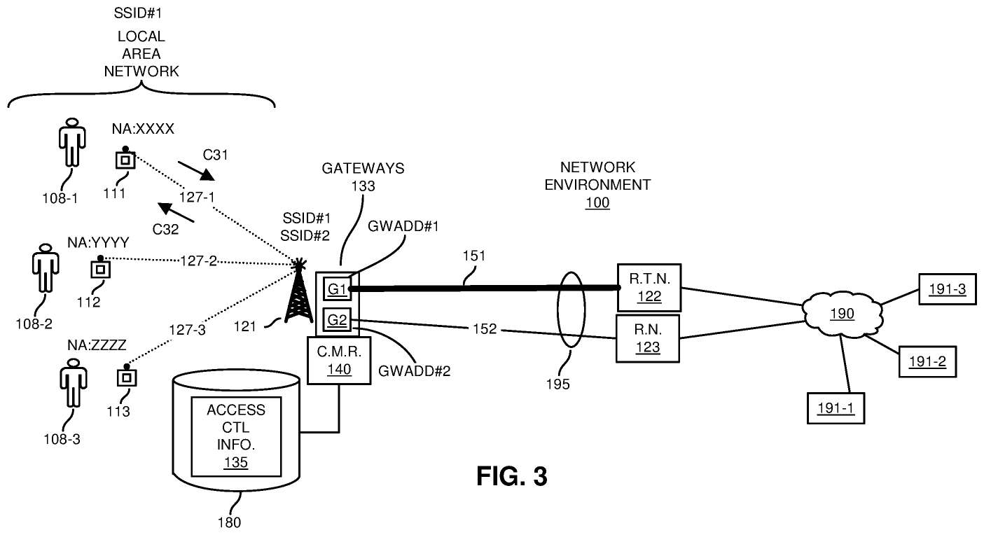

FIG. 3 is an example diagram illustrating assignment of the respective first gateway network address for use by a first communication device as discussed herein.

As previously discussed, the wireless access point 121 (such as a router) uses the corresponding access control information 135 to control conveyance of outbound communications from the first local area network as identified by the network name SSID #1. As previously discussed, the local area network supports communications amongst each of the communication devices 111, 112, and 113.

In this example, in furtherance of establishing or subsequent to establishing the wireless communication link 127-1, via communications C31, assume that the mobile communication device 111 communicates its identity information to the wireless access point 121. The identity information can include any suitable information such as network address XXXX assigned to the mobile communication device 111, MAC address assigned to the mobile communication device 111, etc.

In such an instance, the wireless access point 121 receives a wireless message (C31) from the first mobile communication device 111. The wireless access point 121 may receive the wireless message from the communication device 111 while the mobile communication device 111 is connected to or attempting to connect to the wireless access point 121 via the first local area network as indicated by the SSID #1.

As previously mentioned, the message received from the mobile communication device 111 may include any suitable information such as the network address XXXX assigned to the mobile communication device 111 and/or a corresponding MAC network address assigned to the mobile communication device 111. Based on an identity of the first communication device 111 (such as indicated by the one or more network address information assigned to the mobile communication device 111), the communication management resource 140 associated with the wireless access point 121 or other suitable entity selects a first gateway network address GWADD #1 amongst multiple gateway network addresses (such as gateway network address GWADD #1, GWADD #2).

In other words, in this example, upon receiving the message C31 from the mobile communication device 111, the communication management resource 140 associated with the wireless access point 121 can be configured to retrieve a unique identifier value (indicating an identity of the mobile communication device 111) from the received wireless message. The communication management resource 140 uses the unique identifier value associated with the mobile communication device 111 to determine which of the multiple gateways 133 (such as a first gateway assigned the gateway network address GWADD #1, a second gateway assigned the gateway network address GWADD #1, and so on) is associated with the unique identifier value of the mobile communication device 111. Using the access control information 135, the communication management resource 140 maps the unique identifier value XXXX or MAC network address associated with the mobile communication device 111 to the access control information 135-1 indicating the first gateway network address GWADD #1 amongst the multiple gateway network addresses. In other words, the access control information 135-1 indicates that the mobile communication device 111 is assigned the gateway network address GWADD #1 to support communications outside of the local area network when using the network SSID #1.

Thus, in one example, the communication management resource 140 maps the identity of the mobile communication device 111 to the access control information 135-1 assigned to the mobile communication device 100. The access control information 135-1 supports wireless connectivity associated with the local area network (SSID #1). Assume in this example, that the access control information 135-1 indicates the gateway network address GWADD #1 for use by the mobile communication device 111 as previously discussed.

Because the mobile communication device 111 has joined as a member of the corresponding local area network with the network name SSID #1, the mobile communication device 111 is able to communicate with each of the other mobile communication devices including mobile communication device 112, and mobile communication device 113.

The communication management resource 140 assigns the first gateway network address GWADD #1 to the first communication device 111 for delivery of subsequent first communications from the first communication device 111 to one or more destination devices (191-1, 191-2, 191-3, etc.) in the remote network 190. In one example, assignment of the first gateway network address GWADD #1 to the mobile communication device 111 includes communication of the gateway network address GWADD #1 in the communications C32 to the mobile communication device 111.

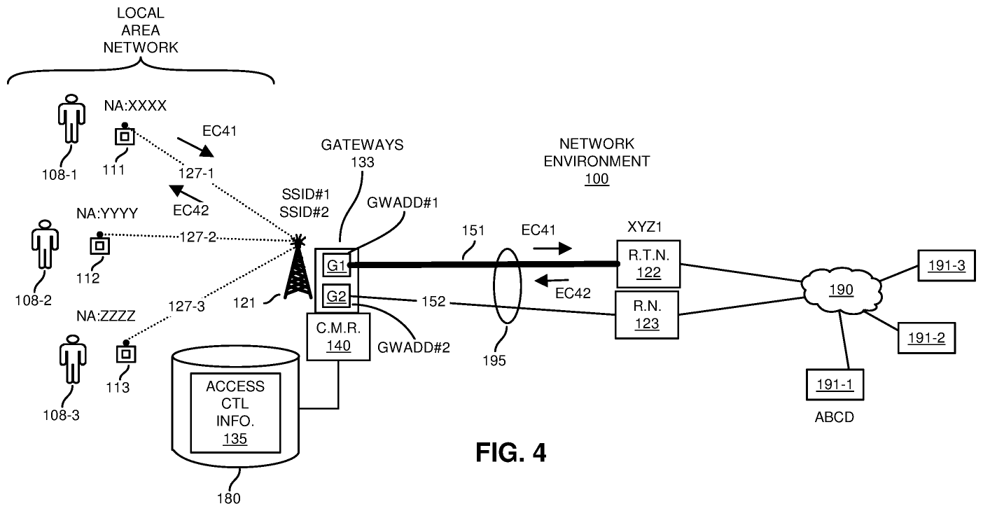

Subsequent to receiving the communications C32, the mobile communication device 111 is now able to use the assigned first gateway G1 associated with the first gateway network address GWADD #1 to communicate through the wireless access point 121 to the remote network 190. Additional details of supporting communications from the mobile communication device 111 outside of the local area network is shown and discussed in FIG. 4.

FIG. 4 is an example diagram illustrating forwarding of first communications from the first communication device using the assigned first gateway network address as discussed herein.

Subsequent to receiving notification of assignment of the first gateway network address GWADD #1, as shown in FIG. 4, the mobile communication device 111 is able to communicate with one or more communication devices (such as servers, computers, etc.) in the network environment 100 via encapsulated communications conveyed over the tunnel 151.

In one example, the mobile communication device 111 uses the learned gateway network address GWADD #1 (such as indicated via communications C32 as previously discussed in FIG. 3) as a basis in which to communicate data packets (such as encapsulated communications EC41) outside of the local area network for delivery through the wireless access point 121 to one or more target communication devices 191 in the network 190 as specified by those one or more encapsulated communications EC41.

Note that the tunnel 151 can extend between the wireless access point 121 and the remote termination of 122. Additionally or alternatively, the tunnel 151 can be configured to extend as a communication path between the mobile communication device 111 through the wireless access point 121 to the remote termination node 122 (such as a wireless access gateway or other suitable entity).

In one example, to support communications outbound from the wireless access point 121 to the network 190, the communication management resource 140 can be configured to communicate with the remote termination node 122 (such as a wireless access gateway or other suitable entity) to set up a respective tunnel 151 to support conveyance of communications EC41 in a upstream direction such as from the communication device 111 through the tunnel 151 (such as passing through one or more of the wireless communication link 127-1, the wireless access point 121, the gateway G1 over the associated with the communication device 111, shared communication link 195). In such an instance, the first gateway network address GWADD #1 is assigned to the communication device 111 to support conveyance of the first communications EC41 between at least the wireless access point 121 (such as router) and a remote termination node 122. In other words, the first gateway network address GWADD #1 supports conveyance of the first communications EC41 over a secure tunnel 151 between the router (121) and the remote termination node 122.

In the downstream direction, communications C42 received from the one or more communication devices 191 are received by the remote termination node 122. The remote termination node 122 can be configured to encapsulate the communications for secure transmission over the tunnel 151 to the wireless access point 121. The wireless access point forwards the communications EC42 over the wireless communication link 127-1 to the mobile communication device 111.

Accordingly, the tunnel 151 can be configured to support secured (such as encrypted) communications in both directions.

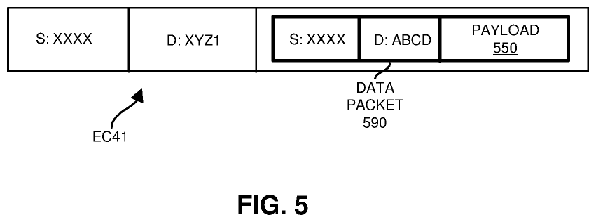

Further details of the first communications EC41 or shown in FIG. 5.

FIG. 5 is an example diagram illustrating an encapsulated data packet supporting outbound communications from the first communication device and the local area network to one or more communication devices in the remote network as discussed herein.

As previously discussed, the mobile communication device 111 or other suitable entity can be configured to generate communications (such as communications EC41) destined for delivery to the one or more communication devices in the network 190.

Assume in this example that the communication device 111 generates the data packet 590 for delivery to the communication device 191-1 assigned the network address ABCD. In such an instance, the communication device 111 or other suitable entity generates the data packet 590 (inner data packet) to include a source network address of XXXX indicating that the communication device 111 is the sender of the data packet 590. The communication device 111 further generates the data packet 590 to include the destination network address ABCD associated with the communication device 191-1. Additionally, the communication device 111 generates a data packet 590 to include the corresponding data payload 550 for delivery to the communication device 191-1 (such as a server or other suitable entity).

As previously discussed, the mobile communication device 111 can be configured to assign the first gateway network address GWADD #1 for delivery of communications outside of the local area network. In such an instance, to communicate the data packet 590 outside of the local area network, the communication device 111 or other suitable entity encapsulates the data packet 590 to produce the encapsulated communication EC41. If desired, the data packet 590 is encrypted. The communication device 111 or other suitable entity generates the encapsulated communication EC41 to further include its source network address XXXX and identification of the assigned gateway address GWADD #1 for delivery to the remote termination node 122.

During the forwarding process, the wireless access point 121 can be configured to receive the encapsulated communication EC41 transmitted over the wireless communication link 127-1 from the communication device 111. The communication management resource 140 and corresponding wireless access point 121 forward the received communication EC41 over the tunnel to the remote termination node 122.

The remote termination node 122 is notified by the communication management resource 140 or other suitable entity of the tunnel being established between the communication device 111 and the remote termination node 122. The notification from the communication management resource 140 may include a corresponding decryption key to convert the received encapsulated communication EC41 into the data packet 590. In such an instance, in response to receiving the communication EC41, the remote termination node 122 applies the appropriate decryption key to obtain the original data packet 590. In accordance with the destination network address as specified by the data packet 590, the remote termination node 122 forwards the data packet 590 over the network 190 to the communication device 191-1.

Accordingly, the communication management resource 140 transmits the first communications EC41 from the wireless access point 121 (router) via the selected first gateway network address GWADD #1 through the secure tunnel 151 for subsequent delivery to the destination ABCD.

This example illustrates how the mobile communication device 111 is able to establish wireless connectivity with the wireless access point 121 using the SSID #1 to be part of a local area network. Assignment and/or allocation of the first gateway and corresponding first gateway network address GWADD #1 to the mobile communication device 111 enables the mobile communication device 111 and wireless access point 121 to transmit outbound traffic with respect to the local area network such that the wireless access point 121 and communication management resource 140 are able to appropriately forward such traffic to the appropriate one or more different destinations as specified by the encapsulated communications generated by the communication device 111.

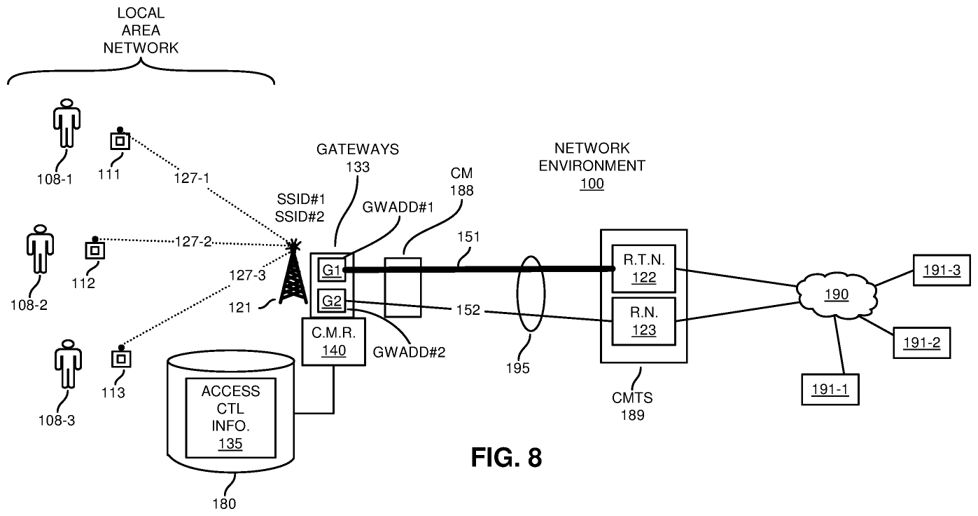

Yet further, as previously discussed, one or more of the wireless access point 121, the communication management resource 140, gateway G1, remote termination node 122, shared communication link 195, etc., can be configured to provide a specific quality of service (such as a bit rate of 1 gigabytes per second) for those communications EC41. Additional details of controlling a rate of conveying communications is discussed with respect to FIG. 8.

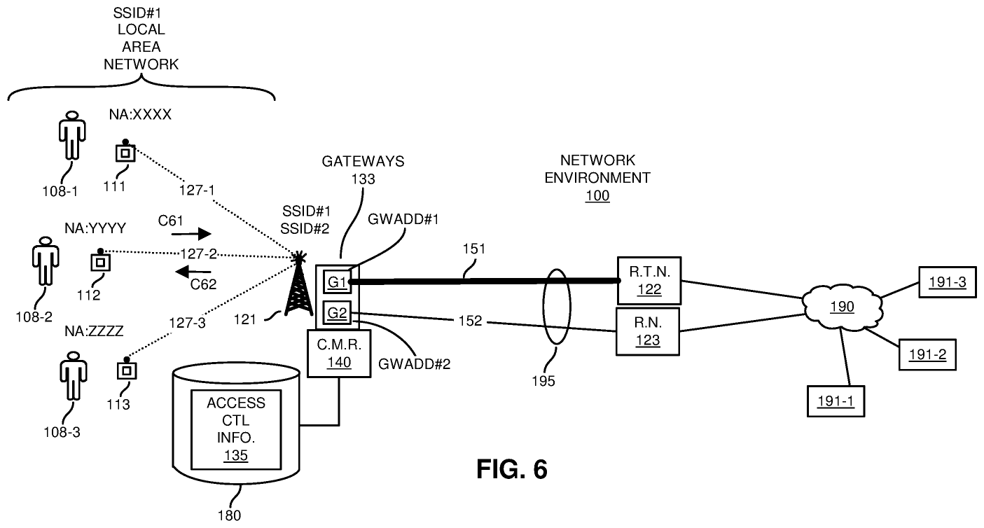

FIG. 6 is an example diagram illustrating assignment of the respective first gateway network address for use by a second communication device as discussed herein.

As previously discussed, the wireless access point 121 (such as a router) uses the corresponding access control information 135 to control conveyance of outbound communications from the first local area network as identified by the network name SSID #1.

In this example, in furtherance of establishing or subsequent to establishing the wireless communication link 127-2, via communications C61, assume that the mobile communication device 112 communicates its identity information to the wireless access point 121 and corresponding communication management resource 140 associated with gateways 133. The identity information received from the communication device 112 or other suitable entity can include any suitable information such as network address YYYY assigned to the mobile communication device 112, MAC address assigned to the mobile communication device 112, etc.

In such an instance, the wireless access point 121 and corresponding communication management resource 140 receive a wireless message (C61) from the second mobile communication device 112. The wireless access point 121 may receive the wireless message (C61) from the communication device 112 while the mobile communication device 112 is connected to or attempting to connect to the wireless access point 121 via the first local area network as indicated by the SSID #1.

As previously mentioned, the message received from the mobile communication device 112 may include any suitable information such as the network address YYYY assigned to the mobile communication device 112 and/or a corresponding MAC network address assigned to the mobile communication device 112. Based on an identity of the communication device 112 (such as indicated by the one or more network address information assigned to the mobile communication device 112), the communication management resource 140 associated with the wireless access point 121 or other suitable entity selects a second gateway network address GWADD #2 amongst multiple gateway network addresses (such as gateway network address GWADD #1, GWADD #2) for use by the mobile communication device 112.

In other words, upon receiving or in response to receiving the message C61 from the mobile communication device 112, the communication management resource 140 associated with the wireless access point 121 can be configured to retrieve a unique identifier value (indicating an identity of the mobile communication device 112) from the received wireless message. The communication management resource 140 uses the unique identifier value associated with the mobile communication device 112 to determine which of the multiple gateways (such as a first gateway assigned the gateway network address GWADD #1, a second gateway assigned the gateway network address GWADD #1, and so on) associated with the received unique identifier value associated with the communication device 112.

Using the access control information 135, the communication management resource 140 maps the unique identifier value YYYY or MAC network address associated with the mobile communication device 112 to the gateway network address GWADD #2 amongst the multiple gateway network addresses.

In one example, the communication management resource 140 maps the identity of the mobile communication device 112 to the access control information 135-2 assigned to the mobile communication device 112. The access control information 135-2 supports wireless connectivity associated with the local area network (SSID #1). Assume in this example, that the access control information 135-2 indicates that the gateway network address GWADD #2 is assigned for use by the mobile communication device 112.

As previously discussed, because the mobile communication device 112 has joined as a member of the corresponding local area network with the network name SSID #1, the mobile communication device 112 is able to communicate with each of the other mobile communication devices including mobile communication device 111, and mobile communication device 113.

The communication management resource 140 assigns the second gateway network address GWADD #2 to the second communication device 112 for delivery of subsequent communications from the second communication device 112 to one or more destination devices (191-1, 191-2, 191-3, etc.) in the remote network 190. In one example, assignment of the first gateway network address GWADD #2 to the mobile communication device 112 includes communication of the gateway network address GWADD #2 in the communications C62 to the mobile communication device 112.

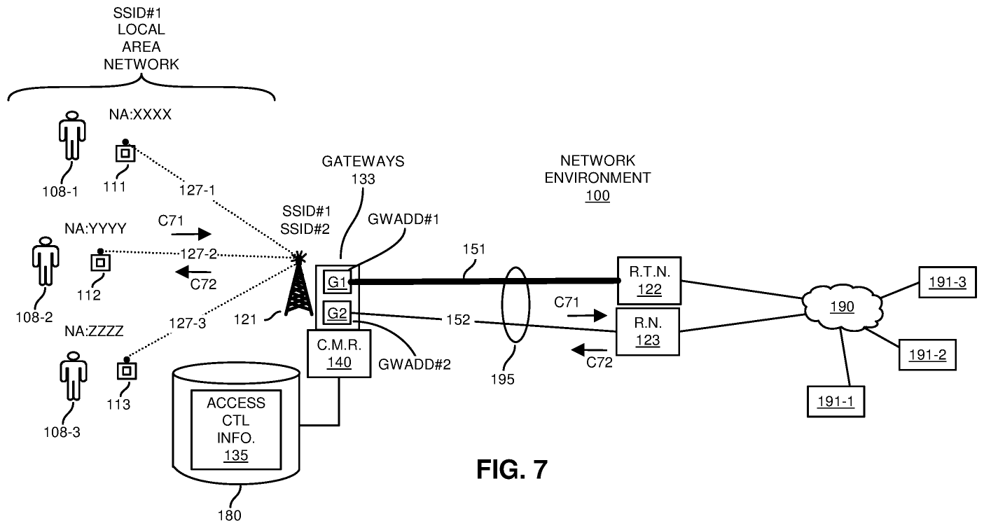

Subsequent to receiving the communications C62, the mobile communication device 112 is now able to use the assigned first gateway G2 associated with the first gateway network address GWADD #2 to communicate through the wireless access point 121 to the remote network 190. Additional details of supporting communications from the mobile communication device 112 outside of the local area network is shown and discussed in FIG. 7.

FIG. 7 is an example diagram illustrating forwarding of first communications from the second communication device using the second gateway network address as discussed herein.

Subsequent to receiving notification of assignment of the gateway network address GWADD #2, the mobile communication device 112 is able to communicate with one or more communication devices (such as servers, computers, etc.) in the network environment 100 via communications conveyed over the communication link 152 supported by the shared communication link 195.

In one example, the mobile communication device 112 uses the learned gateway network address GWADD #2 (such as via communications C62) as a basis in which to communicate data packets from the communication device 112 outside of the local area network for delivery to one or more target communication devices 191 in the network 190 as specified by those one or more communications C71.

Note that the communication link 152 can be configured to extend between the wireless access point 121 and the remote node 123. Alternatively, the communication link 152 can be configured to extend as a communication path between the mobile communication device 112 through the wireless access point 121 to the remote node 123.

In one example, the communication management resource 140 can be configured to communicate with the remote node 123 to support conveyance of communications C71 in an upstream direction such as from the communication device 112 through the communication link 152 (such as passing through one or more of the wireless communication link 127-2, the wireless access point 121, the gateway G2 over the shared communication link 152). In such an instance, the second gateway network address GWADD #2 is assigned to the communication device 112 to support conveyance of the second communications C72 between at least the wireless access point 121 (such as a router) and a remote node 123; the gateway network address GWADD #2 supports conveyance of the second communications C71 over the communication link 152 between the router and the remote node 123.

In the downstream direction, communications C72 received from the one or more communication devices 191 at the remote node 123 are further transmitted from the remote node 123 over the communication link 152 to the second gateway G2. The communication management resource 140 and corresponding wireless access point 121 forward the communication C72 over the wireless communication link 127-2 to the mobile communication device 112.

FIG. 8 is an example diagram illustrating implementation of a communication system to support communications between a respective wireless access point and a remote network as discussed herein.

In this example, the network environment 100 includes a cable modem communication system supporting connectivity over the shared communication link 195 between the wireless access point 121 and the remote termination node 122 and network 190.

For example, the shared communication link 195 (such as the tunnel 151 and the communication link 152) is supported by a link between the cable modem 188 and the cable modem termination system 189. A combination of the cable modem 188 and the cable modem termination system 189 control a respective rate of conveying the communications (a specified by the access control information 135) over the tunnel 151 and the communication link 152 of the shared communication link 195.

As a more specific example, the combination of the cable modem 188 and the cable modem termination system 189 can be configured to receive flow control information associated with the mobile communication device 111 (as indicated by the access control information 135) such as that the communications associated with the mobile communication device 111 are limited to the data flow rate of 1 gigabyte per second over the tunnel 151.

The combination of the cable modem 188 and the cable modem termination system 189 can be configured to determine from the conveyed communications which communications are transmitted from the mobile communication device 111 in an upstream direction from the wireless access point 121 through the shared communication link 195 to the destination network 190 and apply an appropriate data flow rate of 1 gigabyte per second to communications transmitted by the mobile communication device 111.

In the downstream connection, the combination of the cable modem 188 and the cable modem termination system 189 can be configured to determine from the conveyed communications which communications are transmitted to the mobile communication device 111 in and apply an appropriate data flow rate of 1 gigabyte per second to communications transmitted to the mobile communication device 111.

Accordingly, the cable modem communication system can be configured to receive policy information indicating the corresponding flowrate associated with conveyance of data packets transmitted from each of the communication devices transmitted to each of the communication devices. The cable modem termination system controls the uplink and downlink data rates.

The combination of the cable modem 188 and the cable modem termination system 189 can be configured to determine from the conveyed communications which communications are transmitted from the mobile communication device 112 in an upstream direction from the wireless access point 121 through the shared communication link 195 to the destination network 190 and apply an appropriate data flow rate of 200 megabytes per second to communications transmitted by the mobile communication device 112.

In the downstream connection, the combination of the cable modem 188 and the cable modem termination system 189 can be configured to determine from the conveyed communications which communications are transmitted to the mobile communication device 112 and apply an appropriate data flow rate of 200 megabytes per second to communications transmitted downstream to the mobile communication device 112.

Accordingly, the communication management resource 140 can be configured to provide notification of the different data flow rates assigned to each of the communication devices in the local area network to the cable modem 188 and the cable modem termination system 189 for application of a respective control policy.

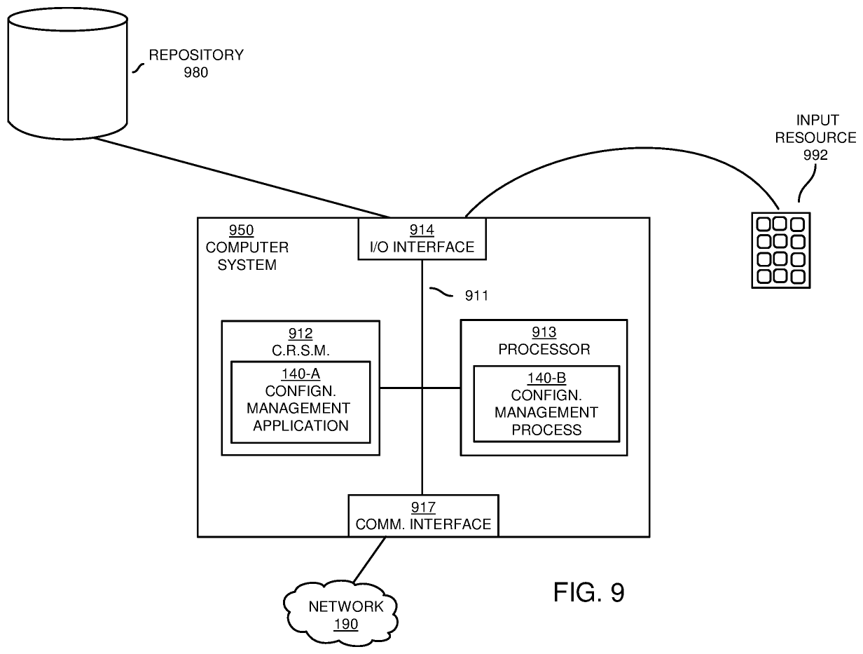

FIG. 9 is an example block diagram of a computer system for implementing any of the operations as previously discussed according to embodiments herein.

Any of the resources (such as communication management resource 140, wireless access point 121, communication device 111, communication device 112, remote termination node 122, remote node 123, cable modem 188, cable modem termination system 189, etc.) as discussed herein can be configured to include computer processor hardware and/or corresponding executable instructions to carry out the different operations as discussed herein.

As shown, computer system 950 of the present example includes an interconnect 911 coupling computer readable storage media 912 such as a non-transitory type of media (which can be any suitable type of hardware storage medium in which digital information can be stored and retrieved), a processor 913 (computer processor hardware), I/O interface 914, and a communications interface 917.

I/O interface(s) 914 supports connectivity to repository 980 and input resource 992.

Computer readable storage medium 912 can be any hardware storage device such as memory, optical storage, hard drive, floppy disk, etc. In one embodiment, the computer readable storage medium 912 stores instructions and/or data.

As shown, computer readable storage media 912 can be encoded with management application 140-1 (e.g., including instructions) to carry out any of the operations as discussed herein.

During operation of one embodiment, processor 913 accesses computer readable storage media 912 via the use of interconnect 911 in order to launch, run, execute, interpret or otherwise perform the instructions in management application 140-1. For the management application 140-1 stored on computer readable storage medium 912. Execution of the communication management application 140-1 produces management process 140-2 to carry out any of the operations and/or processes as discussed herein.

Those skilled in the art will understand that the computer system 950 can include other processes and/or software and hardware components, such as an operating system that controls allocation and use of hardware resources to execute communication management application 140-1.

In accordance with different embodiments, note that computer system may reside in any of various types of devices, including, but not limited to, a mobile computer, a personal computer system, a wireless device, a wireless access point, a base station, phone device, desktop computer, laptop, notebook, netbook computer, mainframe computer system, handheld computer, workstation, network computer, application server, storage device, a consumer electronics device such as a camera, camcorder, set top box, mobile device, video game console, handheld video game device, a peripheral device such as a switch, modem, router, set-top box, content management device, handheld remote control device, any type of computing or electronic device, etc. The computer system 950 may reside at any location or can be included in any suitable resource in any network environment to implement functionality as discussed herein.

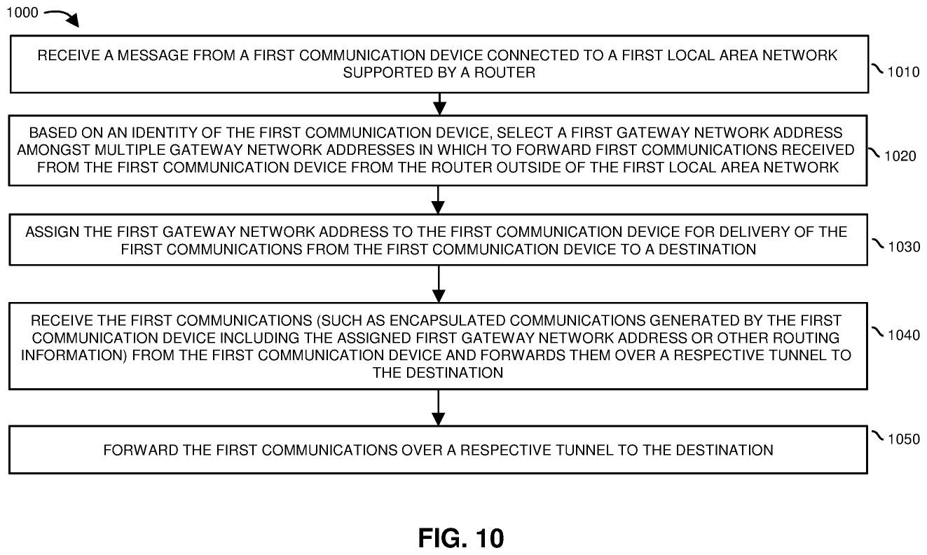

Functionality supported by the different resources will now be discussed via method flowcharts in FIG. 10. Note that the steps in the flowcharts below can be executed in any suitable order.

FIG. 10 is a flowchart 1000 illustrating an example method according to embodiments. Note that there will be some overlap with respect to concepts as discussed above.

In processing operation 1010, a router such as wireless access point 121 receives a message from a first communication device connected to a first local area network supported by the router.

In processing operation 1020, based on an identity of the first communication device, the communication management resource associated with the router selects a first gateway network address amongst multiple gateway network addresses in which to forward first communications received from the first communication device from the router outside of the first local area network.

In processing operation 1030, the communication management resource assigns and/or provides the first gateway network address to the first communication device for delivery of the first communications from the first communication device to a destination.

In processing operation 1040, the router receives the first communications (such as encapsulated communications generated by the first communication device including the assigned first gateway network address or other routing information) from the first communication device.

In processing operation 1050, the router forwards the over a respective tunnel to one or more destinations.

Note again that techniques herein are well suited to control of data flows in a wireless network environment. However, it should be noted that embodiments herein are not limited to use in such applications and that the techniques discussed herein are well suited for other applications as well.

Based on the description set forth herein, numerous specific details have been set forth to provide a thorough understanding of claimed subject matter. However, it will be understood by those skilled in the art that claimed subject matter may be practiced without these specific details. In other instances, methods, apparatuses, systems, etc., that would be known by one of ordinary skill have not been described in detail so as not to obscure claimed subject matter. Some portions of the detailed description have been presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm as described herein, and generally, is considered to be a self-consistent sequence of operations or similar processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has been convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a computing platform, such as a computer or a similar electronic computing device, that manipulates or transforms data represented as physical electronic or magnetic quantities within memories, registers, or other information storage devices, transmission devices, or display devices of the computing platform.

While this invention has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting. Rather, any limitations to the invention are presented in the following claims.

We claim:

1. A method comprising:
at a router, receiving a wireless message from a first communication device connected to a first local area network supported by the router;
based on an identity of the first communication device, selecting a first gateway network address amongst multiple gateway network addresses in which to forward first communications received from the first communication device to at least one destination outside of the first local area network; and
assigning the first gateway network address to the first communication device for delivery of the first communications from the first communication device to the at least one destination.

2. The method as in claim 1, wherein the first local area network supports conveyance of second communications amongst multiple communication devices connected to the first local area network, the multiple communication devices including the first communication device and a second communication device.

3. The method as in claim 1, wherein the first gateway network address is assigned to support conveyance of the first communications between the router and a remote termination node, the first gateway network address supporting conveyance of the first communications over a secure tunnel between the router and the remote termination node.

4. The method as in claim 3, wherein the remote termination node is a wireless access gateway.

5. The method as in claim 3 further comprising:
transmitting the first communications from the router via the selected first gateway network address through the secure tunnel to the at least one destination.

6. The method as in claim 1 further comprising:
receiving the first communications as encapsulated messages generated by the first communication device; and
transmitting the first communications from the router through a secure tunnel associated with the first gateway network address for delivery to the at least one destination.

7. The method as in claim 1, wherein the first local area network is a first wireless network;
wherein the wireless message is received from the first communication device over the first local area network supported by the router, the first local area network providing wireless connectivity of the first communication device to a second communication device in the wireless network through the router, the method further comprising:
transmitting the first communications as encapsulated messages over a secure tunnel associated with the first gateway network address to the at least one destination.

8. The method as in claim 1, wherein receiving the wireless message includes receiving the wireless message in a wireless signal transmitted from the first communication device to the router.

9. The method as in claim 1, wherein selecting the first gateway network address includes:
retrieving a unique identifier value from the wireless message, the unique identifier value indicating the identity of the first communication device; and
mapping the unique identifier value to the first gateway network address amongst the multiple gateway network addresses.

10. The method as in claim 9 further comprising:
receiving a second wireless message from a second communication device, the second communication device connected to the first local area network supported by the router;
based on an identity of the second communication device, selecting a second gateway network address amongst the multiple gateway network addresses in which to forward second communications received from the second communication device from the router outside of the first local area network; and
transmitting the second communications from the router to the selected second gateway network address for delivery of the second communications to a destination as specified by the second communications.

11. The method as in claim 10, wherein selecting the second gateway network address includes:
retrieving a unique identifier value from the second wireless message, the unique identifier value retrieved from the second wireless message specifying an identity of the second communication device; and
mapping the unique identifier value retrieved from the second wireless message to the second gateway network address.

12. The method as in claim 11, wherein the first communication device and the second communication device are in communication with each other over the first local area network, the first local area network being a first virtual wireless network supported by the router.

13. The method as in claim 12, wherein receiving the wireless message from the first communication device includes: wirelessly receiving the message from the first communication device over the first local area network; and
wherein receiving the second wireless message from the second communication device includes: wirelessly receiving the second wireless message from the second communication device over the first local area network.

14. A system comprising:
communication management hardware operative to:
receive a wireless message from a first communication device connected to a first local area network supported by a router;
based on an identity of the first communication device, select a first gateway network address amongst multiple gateway network addresses in which to forward first communications received from the first communication device to at least one destination outside of the first local area network; and
assign the first gateway network address to the first communication device for delivery of the first communications from the first communication device to the at least one destination.

15. The system as in claim 14, wherein the first local area network supports conveyance of second communications amongst multiple communication devices connected to the first local area network, the second communications transmitted within the first local area network, the multiple communication devices including the first communication device and a second communication device.

16. The system as in claim 14, wherein the first gateway network address is assigned to support conveyance of the first communications between the router and a remote termination node, the first gateway network address supporting conveyance of the first communications over a secure tunnel between the router and the remote termination node.

17. The system as in claim 16, wherein the remote termination node is a wireless access gateway.

18. The system as in claim 14, wherein the communication management hardware is further operative to:
transmit the first communications from the router via the selected first gateway network address through the secure tunnel to the at least one destination.

19. The system as in claim 14, wherein the communication management hardware is further operative to:
receive the first communications as encapsulated messages generated by the first communication device; and
transmit the first communications from the router through a secure tunnel associated with the first gateway network address for delivery to the at least one destination.

20. The system as in claim 14, wherein the first local area network is a first wireless network;
wherein the wireless message is received from the first communication device over the first local area network supported by the router, the first local area network providing wireless connectivity of the first communication device to a second communication device in the wireless network through the router;
wherein the communication management hardware is further operative to:
transmit the first communications as encapsulated messages over a secure tunnel associated with the first gateway network address to the at least one destination.

21. The system as in claim 14, wherein the communication management hardware is further operative to:
receive the wireless message in a wireless signal transmitted from the first communication device to the router.

22. The system as in claim 14, wherein the communication management hardware is further operative to:
retrieve a unique identifier value from the wireless message, the unique identifier value indicating the identity of the first communication device; and
map the unique identifier value to the first gateway network address amongst the multiple gateway network addresses.

23. Computer-readable storage hardware having instructions stored thereon, the instructions, when carried out by computer processor hardware, cause the computer processor hardware to:
receive a wireless message from a first communication device connected to a first local area network supported by the router;
based on an identity of the first communication device, select a first gateway network address amongst multiple gateway network addresses in which to forward first communications received from the first communication device to at least one destination outside of the first local area network; and
assign the first gateway network address to the first communication device for delivery of the first communications from the first communication device to the at least one destination.
